(19) United States
(12) Patent Application Publication
(10) Pub. No.: US 2013/0100291 A1
(43) Pub. Date: Apr. 25, 2013

(54) DEVICE FOR HANDLING BANKNOTES

(71) Applicant: Wincor Nixdorf International GmbH, Paderborn (DE)

(72) Inventors: Chee Seng TAN, Singapore (SG); Rahunandan KANDASAMY, Singapore (SG); Tee Meng PANG, Singapore (SG)

(73) Assignee: Wincor Nixdorf International GmbH, Paderborn (DE)

(21) Appl. No.: 13/654,728

(22) Filed: Oct. 18, 2012

(30) Foreign Application Priority Data
Oct. 21, 2011 (EP) 11 186 147.2

(51) Int. Cl. H04N 7/18

(52) U.S. Cl. 348/150; 348/E07.085

(57) ABSTRACT

The invention relates to a device (10) for handling banknotes. The device (10) comprises a display unit (12) which is tiltable about an axis of rotation (40), a drive unit (34) for changing the tilt of the display unit (12) about the axis of rotation (40), and a camera (38) for capturing an image of an area in front of the device (10) opposite to the display unit (12). The camera (38) generates image data corresponding to the image. Based on the position of a detected body feature, a control unit (36) determines a tilt angle (α) and drives the drive unit (34) such that it adjusts the determined tilt angle (α).

### BACKGROUND OF THE INVENTION

1. Technical Field

The invention relates to a device for handling banknotes, which comprises a display unit having a display surface for displaying at least one graphical user interface to a user of the device.

2. Discussion

The device is in particular an automated teller machine by means of which banknotes can be dispensed to a user and/or banknotes can be deposited by the user. At least one graphical user interface via which the user can control the device is displayed to the user by means of a display unit. In particular, via such a graphical user interface the user is requested to carry out the individual steps required for the deposit and/or the withdrawal of banknotes.

These automated teller machines are used by people of different heights such as, for example, a person sitting in a wheel chair. Further, automated teller machines are known that can be used from inside a vehicle, wherein these vehicles can have very different seat heights. In order to guarantee that the display unit can be read without any problems independent of a position of the user's face relative to the display unit, the display unit is tiltable about an axis of rotation that preferably extends horizontally. What is problematic with these automated teller machines is that the display surface must be tilted manually by the user to a tilt angle suitable for this user, which requires effort in particular when the automated teller machine is used from inside a vehicle.

From U.S. Pat. No. 7,644,039 B1, U.S. Pat. No. 6,812,917 B2, US 2010/0126805 A1 and U.S. Pat. No. 6,296,079 B1, devices with tiltable display surfaces are known.

### SUMMARY OF THE INVENTION

It is an object of the invention to specify a device in which the display surface is oriented according to the relative position of the user to the display surface.

The device for handling banknotes preferably comprises a display unit which is tiltable about an axis of rotation. Further, the device comprises a drive unit for changing the tilt of the display unit about the axis of rotation, and a camera for capturing an image of an area in front of the device opposite to the display unit, the camera generating image data corresponding to the image. Further, the device comprises a control unit for processing the image data. By means of a processing algorithm the control unit detects a body feature of a user in front of the device, in particular the face of the user, the shoulder, the upper edge of the head, the hairline, and/or the eyes. Here, preferably the position of the detected body feature is determined in the image. Based on the determined position of the detected body feature, the control unit determines a tilt angle. Subsequently, the control unit controls the drive unit such that the drive unit adjusts the display surface tilt angle determined by the control unit. In this way, the display surface of the device is automatically ideally oriented dependent on the position of the user relative to the device such that the display surface can be read well and/or used easily by the user.

Preferably, the device comprises at least one further operating element by means of which a tilt angle different from the determined tilt angle can be adjusted by the user. As a result thereof, users that prefer a tilt angle different from the determined tilt angle can adjust their preferred display unit tilt angle.

In an advantageous development of the further operating element, this operating element comprises a first push button for driving the display unit about the axis of rotation in a first direction of rotation and a second push button for driving the display unit about the axis of rotation in a second direction of rotation opposite to the first direction of rotation. By providing two separate push buttons, each push button can, for example, be assigned one pictogram that corresponds to the effect of a use of this push button on the tilt angle of the display unit. This makes it easier for the users to adjust their preferred display unit tilt angle. As an alternative or in addition to the pictogram, singles letters or a text can be provided on each push button, these letters or the text indicating the effect of the use of this push button on the tilt angle of the display unit.

In a preferred embodiment, the display unit comprises a rectangular display surface. This display surface has a first side with a first side length and a second side with a second side length, the first side and the second side enclosing a right angle. A rectangular display surface is the preferred format of a display surface for automated teller machines. With this design of the display surface, standardized user interfaces for automated teller machines can be used.

In a particularly preferred embodiment of the device, this first side is oriented horizontally. In this way, the users can particularly easily view the graphic user interfaces.

It is advantageous when a plurality of push buttons for selecting control information displayed via the user interface are arranged along the second side of the display surface and/or along a third side of the display surface opposite to the second side. By arranging these push buttons next to the display surface in the display unit, these push buttons are likewise tilted when the display unit is tilted about the axis of rotation so that they are always arranged in the same position relative to the display surface. In this way, the control information on the user interface can always be displayed in the same position on the display surface independent of the tilt angle.

In a preferred embodiment, the axis of rotation is oriented horizontally when the device is in the operating position. This allows for a particularly easy orientation of the display unit relative to the user.

In an advantageous embodiment of the device, a home position tilt angle is stored in a preset manner in the control unit. The control unit controls the drive unit such that this home position tilt angle is adjusted whenever a transaction initiated by the user is terminated or when the control unit does not detect any user in the image captured by the camera. By providing a home position tilt angle, the display unit and thus the display surface is in a home position when the device is not used. For example, a tilt angle that is to be adjusted particularly often is assigned to this home position. As a result thereof, particular short adjustment times are achieved.

In a particularly preferred embodiment, the display unit comprises a touch screen. As a result thereof, use of the device is particularly easy. Further, the user interfaces for operating the device can have a simple design and allow for easy navigation.

Further features and advantages of the invention result from the following description which, in connection with the enclosed Figures, explains the invention in more detail with reference to embodiments.

### BRIEF DESCRIPTION OF THE DRAWINGS

FIG. 1 shows a front view of a part of a device for handling banknotes.

FIG. 2 shows a schematic perspective rear view of an arrangement with a display unit and with a drive unit for changing the tilt angle of the display unit.

FIG. 3 shows a schematic cross-section of the arrangement through the cutting plane A-A in FIG. 2.

FIG. 4 shows a schematic cross-section of the arrangement according to FIG. 3, with the display unit tilted downward.

FIG. 5 shows a schematic side view of an optical sensor for determining the tilt angle of the display unit.

FIG. 6 shows a schematic side view of the device according to a further embodiment when used from inside a vehicle.

FIG. 7 shows a flow chart of a program for controlling the device.

FIG. 8 shows a flow chart of a subprogram for adjusting a predetermined adjustment angle.

### DESCRIPTION OF THE PREFERRED EMBODIMENTS

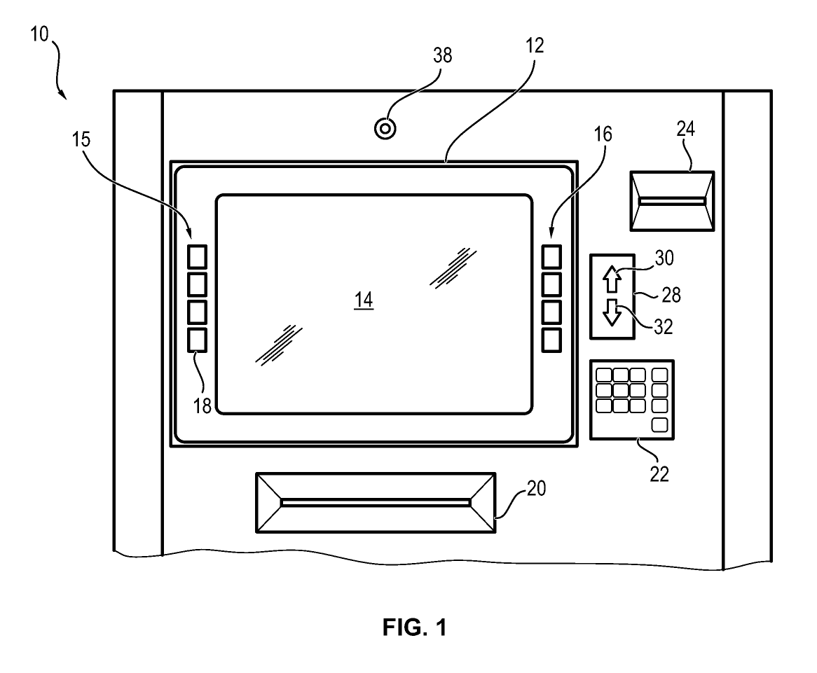

FIG. 1 shows a front view of an upper part of a device 10 for handling banknotes. This part comprises operating elements by which a user operates the device 10. These operating elements comprise an input and output slot 20 for banknotes, a keypad 22 which, for example, serves to enter a PIN, a card reader 24 for a magnetic stripe and/or chip card as well as a tiltable display unit 12. In this embodiment, this display unit 12 comprises a display surface 14 and is designed as an LCD display. But the invention is not limited to an LCD display. Moreover, the display unit comprises two push button panels 15, 16 with four push buttons each, one push button being exemplarily identified with the reference sign 18. Via these push buttons 18, a user can input information. Different functions may be assigned to these push buttons dependent on a displayed graphical user interface.

By means of a camera 38 of the device 10 an image of an area in front of the device 10 can be captured and image data corresponding to the image can be generated. The image data are then processed by means of a control unit of the device 10. A user in front of the device 10 is detected and in particular the user's face is detected, and the position of the face of the user in the image is determined. In addition, the device 10 comprises an operating element 28 via which a user can manually change the tilt angle of the display unit 12. In this embodiment, the operating element 28 is designed as a rocker switch, the two pictograms 30, 32 provided on the rocker switch indicating the operating function of the respective area of the rocker switch.

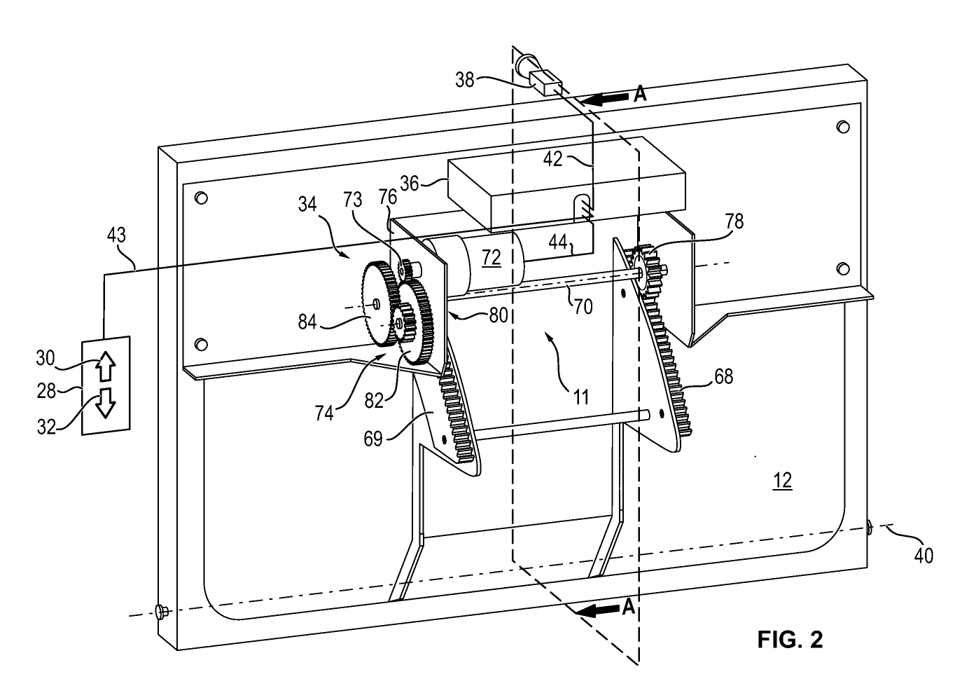

FIG. 2 shows a schematic perspective rear view of an arrangement 11 for tilting the display unit 12 of the device 10 according to FIG. 1. Apart from the display unit 12, the arrangement 11 comprises a drive unit 34. By means of the drive unit 34, the tilt angle of the display unit 12 can be changed. In FIG. 2, apart from the arrangement 11, also the camera 38 and the operating element 28 are illustrated, each of which is connected via a respective schematically illustrated electric line 42, 43 to a control unit 36. The display unit 12 is tiltable about an axis of rotation 40 by means of the drive unit 34.

The drive unit 34 comprises a drive motor 72 which by means of a gear 73 drives a gear unit 74 comprising a stepped gear 82 and a driven gear 84. The driven gear 84 is connected to a shaft 70 in a rotationally fixed manner and drives this shaft upon a rotation of the drive motor 72. Two gears 78, 80 are connected to this shaft 70 in a rotationally fixed manner, wherein the gear 80 is hidden behind a basic plate 76 of the gear unit 74 and is thus not visible in FIG. 2. The first gear 78 engages with the teeth of a first gear segment 68 formed along a circular arc about the axis of rotation 40, and the second gear 80 engages with the teeth of a second gear segment 69 formed along a circular arc about the axis of rotation 40. The two gear segments 68, 69 are connected to the display unit 12 so that the display unit 12 is tilted upward about the axis of rotation 40 in a first direction of rotation when the drive motor 72 is rotated in a first direction of rotation and so that the display unit 12 is tilted downward about the axis of rotation 40 in a second direction of rotation opposite to the first direction of rotation when the drive motor 72 is rotated in a second direction of rotation opposite to the first direction of rotation.

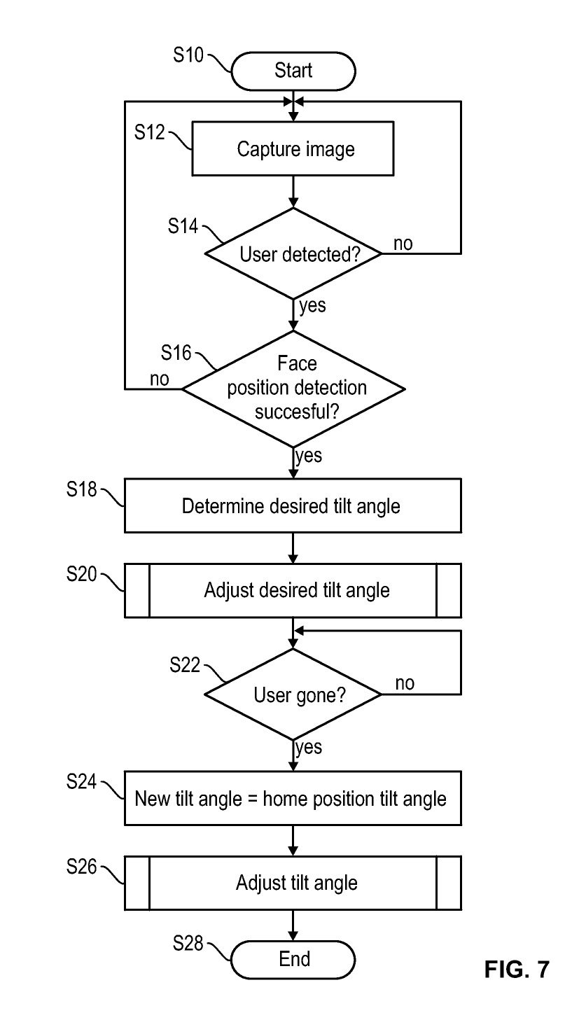

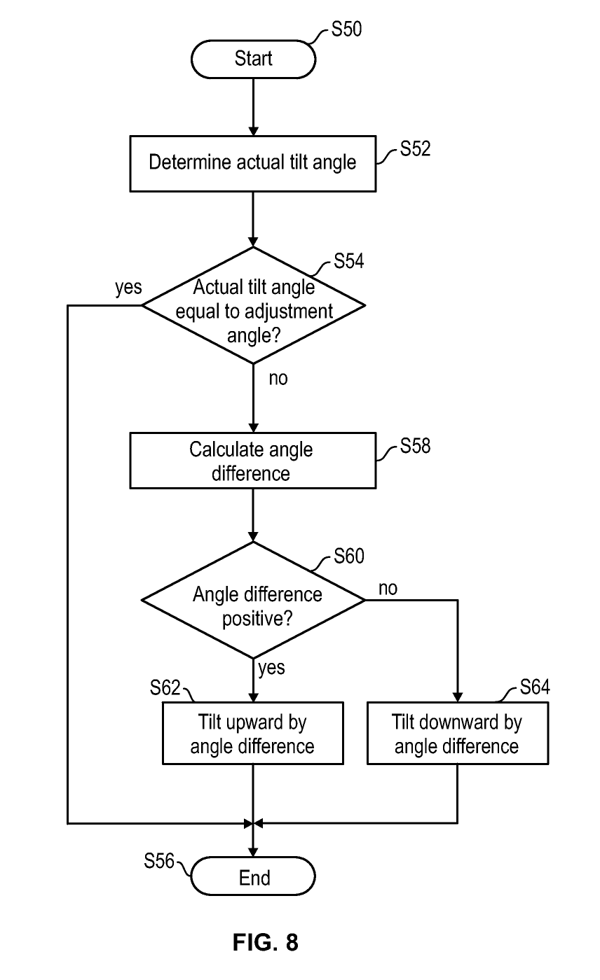

As already mentioned, the camera 38 captures an image of the area in front of the device 10 and generates image data corresponding to the image, which data are transmitted via the electric line 42 to the control unit 36 where they are processed. By means of a sequence described in the following in connection with FIGS. 7 and 8, the control unit 36 determines from the image data generated by means of the camera 38 the position of the user's face in the image and, taking into account this position of the face, it determines a desired tilt angle of the display unit 12 suitable for the user. If the determined desired tilt angle does not correspond to the currently adjusted actual tilt angle of the display unit 12, the control unit 36 drives the drive motor 72 via an electric line 44 such that this drive motor tilts the display unit 12 via the gear unit 74 and the gear segments 68, 69 about the axis of rotation 40 until the determined desired tilt angle is adjusted.

The maximum possible tilt angle from a rest position of the display unit 12 (referred to as home position) is preferably 10° in both directions. In other embodiments, the tilt angle can be varied between 0° and 15° in one or in both directions. Embodiments in which, starting out from the home position, the possible variation of the tilt angle in both directions is different, for example 10° in one direction and 15° in the other direction, are likewise possible. The home position is the position taken by the display unit 12 when no user is detected in the area in front of the device 10.

Further, the user can manually change the tilt angle of the display unit 12 by means of the operating element 28. By pressing the area identified with the pictogram 30 the display unit 12 is tilted upward in the first direction of rotation by means of the drive unit 34, whereas by pressing the area identified with the pictogram 32 the display unit 12 is tilted downward in the second direction of rotation by means of the drive unit 34.

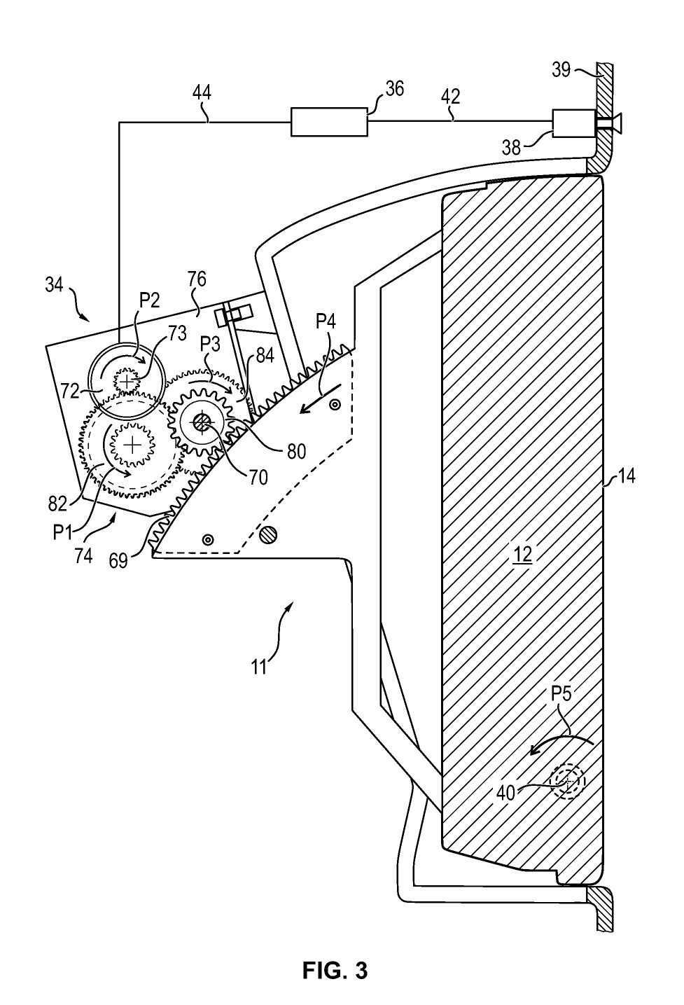

FIG. 3 shows a schematic cross-section of the arrangement 11, the control unit 36 and the camera 38 through the cutting plane A-A illustrated in FIG. 2. In FIG. 3, housing parts 39 of the operating panel of the device 10 are additionally illustrated in cross-section. When a potential user enters the area captured by the camera 38, the camera detects the face and/or another body feature of the potential user and determines the position of the face or, respectively of the other body feature in the captured image. On the basis of this face position a desired tilt angle of the display unit 12 suitable for the user is determined and adjusted, as described in connection with FIG. 2. When, for example, a positive angle difference is determined between the determined actual tilt angle and the desired tilt angle, the display unit 12 must be tilted upward about the axis of rotation 40 in the first direction of rotation which is defined by the arrow P5. For this, the drive motor 72 is connected to the control unit 36 via the electric line 44 so that the drive motor 72 drives the gear 73 connected thereto in the direction of the arrow P2. As a result thereof, the stepped gear 82 of the gear unit 74 is rotated in the direction of the arrow P1, and the driven gear 84 of the gear unit 74 is rotated in the direction of the arrow P3. Thus, the shaft 70 connected to the driven gear 84 in a rotationally fixed manner and the gears 78, 80 connected to the shaft 70 in a rotationally fixed manner are likewise rotated in the direction of the arrow P3. As a result thereof, the gears 78, 80 drive the gear segments 68, 69 in the direction of the arrow P4 so that the gear segments 68, 69 and the display unit 12 connected thereto are rotated about the axis of rotation 40 in the direction of the arrow P5.

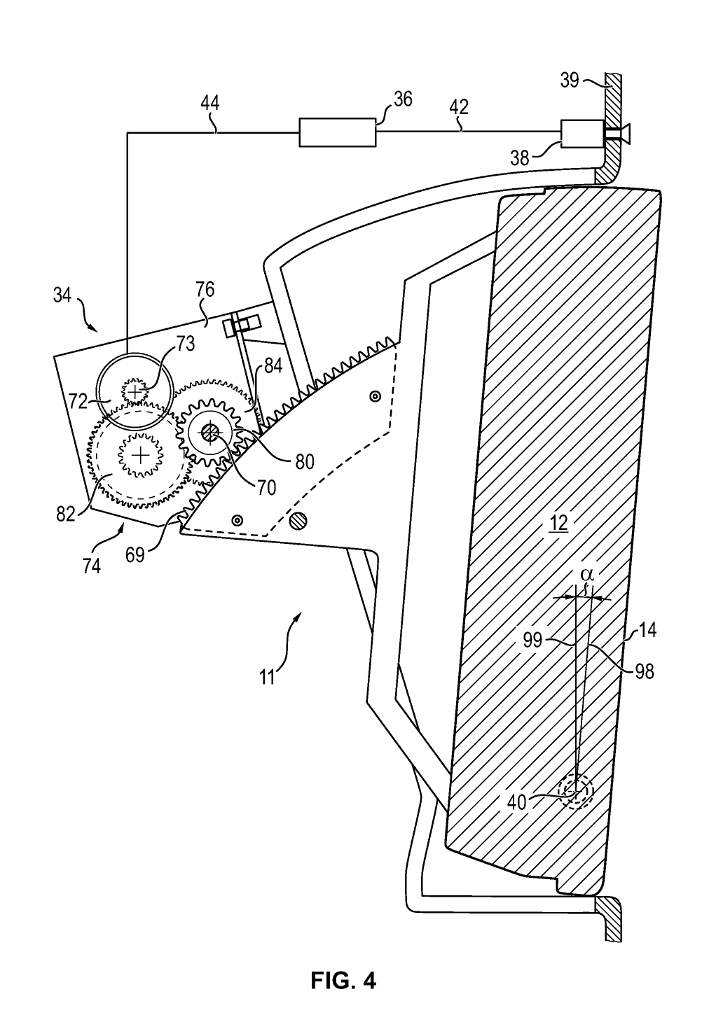

FIG. 4 shows a schematic cross-section of the arrangement 11 according to FIG. 3. Unlike in FIG. 3, the display unit 12 in FIG. 4 is tilted by a tilt angle α in the second direction of rotation opposite to the arrow P5 and thus downward. As a result thereof, also the gear segments 68, 69 connected to the display unit 12 are rotated about the axis of rotation 40 in a direction of rotation opposite to the arrow P5, as compared to the position shown in FIG. 3. The display unit 12 is tilted into the position shown in FIG. 4 for example when a user sitting in a vehicle or in a wheel chair is detected by the control unit 36 in the area captured by the camera 38.

For illustration of the tilt angle α, the legs 98, 99 forming the tilt angle α are illustrated in FIG. 4. The first leg 98 runs parallel to the display surface 14 in the position shown in FIG. 4 and the second leg 99 runs parallel to the position of the display surface 14 in the home position. In other embodiments, the positions of the legs 98, 99 of the tilt angle α can also be oriented differently. In particular, the leg 99 which indicates the tilt of the display plane in the home position can already have a position different from the vertical position so that in this case the display plane is already tilted upward or downward in the home position. Thus, the leg 99 indicates the position of the display plane of the display surface 14 in the home position and the other leg 98 indicates the position of the display plane of the display surface 14 in a position different from the home position. In other embodiments, the tilt angle α can also be referenced to a different plane.

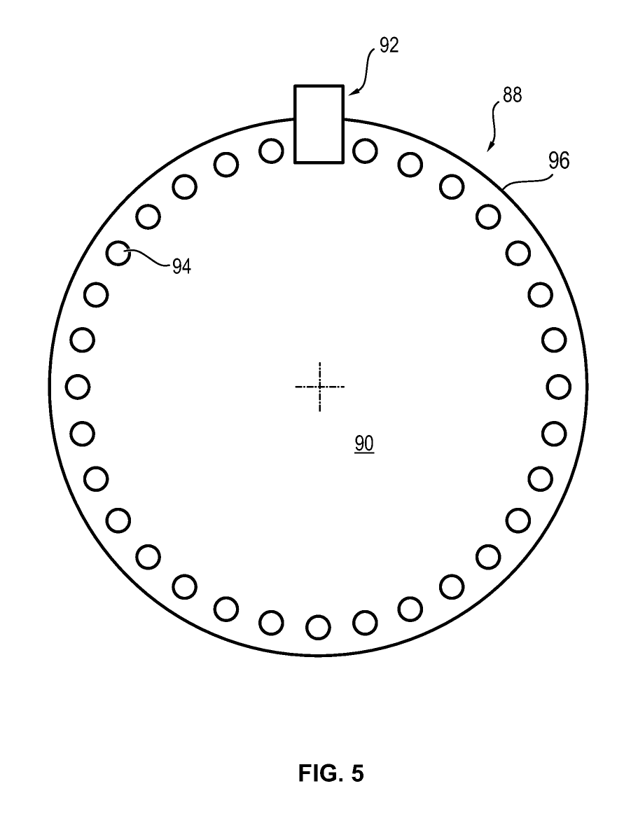

FIG. 5 shows an optical position sensor 88 which is operatively connected to the drive unit 34. This position sensor 88 comprises a perforated disk 90 in which a large number of identical holes are formed along a circumferential line, one of these holes being exemplarily identified with the reference sign 94. Along this circumferential line, the holes 90 are equidistantly spaced. On one side of the perforated disk 90 an optical detector 92, for example a photosensor, is arranged. On the other side of the perforated disk 90, a non-illustrated light source lying opposite to the detector 92 is arranged. When the perforated disk 90 is in a position in which one of the holes 94 is located between the light source and the detector 92, the detector 92 detects the light from the light source. In another position of the perforated disk 90, no hole 94 is arranged between the light source and the detector 92 so that the detector 92 does not detect the light from the light source. Thus, when the perforated disk 92 is rotated, the detector 92 detects a sequence of light pulses from which a change in the angle of rotation of the perforated disk 90 can be determined by counting the light pulses. Dependent on the counted value of detected light pulses, the change in the tilt angle α of the display unit 12 can be determined. In another embodiment, instead of the holes 94 in the perforated disk 90, notches are provided along an edge of a disk, and just as in the case of the perforated disk, the rotation of such a notched disk generates a pulse sequence of light pulses, which pulse sequence is evaluated.

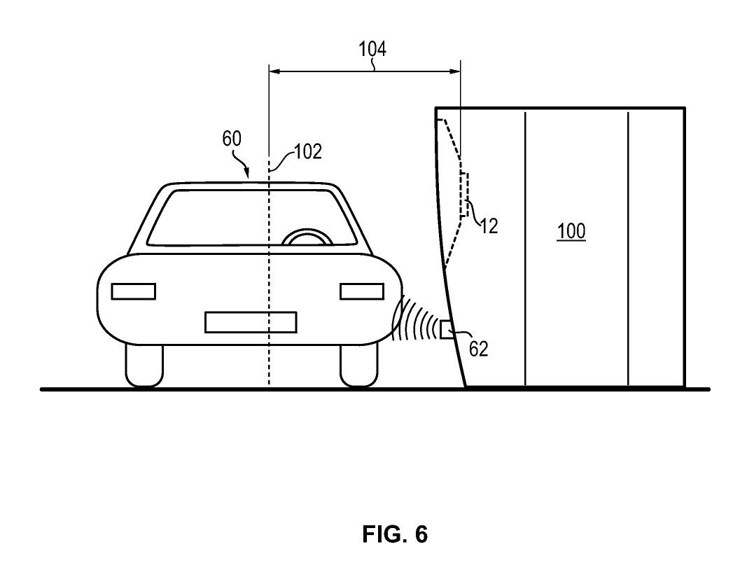

FIG. 6 shows a device 100 according to another embodiment and a vehicle 60, with a user sitting in this vehicle. The device 100 comprises all elements of the device 10 and additionally an ultrasonic sensor 62. The ultrasonic sensor 62 emits sound waves in the ultrasonic range and detects the sound waves reflected on objects. The ultrasonic sensor 62 generates a sensor signal dependent on the transit time between emission and detection of the ultrasonic sound waves. This sensor signal is transmitted to the control unit 36 and evaluated thereat.

Dependent on the sensor signal from the ultrasonic sensor 62, the control unit 36 determines in this embodiment whether an object that may be a vehicle 60 or a user, is present in a detection area in front of the device 100. At the same time, an image of the detection area in front of the device 100 is captured by means of the camera 38, and image data corresponding to the image are generated. The image data are then processed by means of the control unit 36 of the device 100. A user in front of the device 100 or a vehicle 60 in front of the device 100 is detected. When the control unit 36 determines on the basis of the sensor signal the presence of an object in the detection area, then the control unit 36 determines by means of the sequence described below in connection with FIGS. 7 and 8 the position of the user's face in the image from the image data generated by the camera 38 and, taking this face position into account, it determines a desired tilt angle of the display unit 12 that is suitable for the user. If the determined desired tilt angle does not correspond to the currently adjusted actual tilt angle α of the display unit 12, the control unit 36 adjusts the determined desired tilt angle in accordance with the sequence described in FIG. 2.

Alternatively, in another embodiment, in addition to the determined position of the face in the captured image, based on the sensor signal also the distance of the user or, respectively, of the object can be taken into account in the determination of the desired tilt angle to be adjusted.

In FIG. 6, a broken line 102 identifies the preset end of the detection area opposite to the device 100. In this embodiment, the distance 104 between the display unit 12 of the device 100 and the end of the detection area amounts to preferably 0.9 m. In other embodiments of the device 100, the end of the detection area can be defined at a different distance 104, in particular in a range between 0.5 m and 1.2 m.

FIG. 7 shows a flow chart for controlling the device 10. The sequence is started in step S10. Thereafter, in step S12, the camera 38 captures an image of the area in front of the device 10 opposite to the display unit 12 and generates image data corresponding to the image. In step S14, the control unit 36 then processes these image data by means of a processing algorithm. By comparison with data stored in the control unit 36, it is determined whether a user has been detected in the image. If this is not the case, the sequence returns to step S12. If, in step S14, the control unit 36 detects a user on the basis of the image data, then the control unit 36 determines in step S16 the position of a body feature, for example of the face, of the user. If no face position can be determined, the sequence is continued in step S12, otherwise the control unit 36 determines a desired tilt angle assigned to the position of the detected face in step S18.

Thereafter, in step S20, this desired tilt angle is transmitted as adjustment angle to a subprogram described in more detail in the following with reference to FIG. 8. This subprogram adjusts the desired tilt angle.

In step S22, the control unit 36 then checks whether the user has already left the area in front of the device 10. For this, the camera 38 captures an image of the area in front of the device 10 opposite to the display unit 12, generates image data corresponding to this image, and the control unit 36 detects the presence of the user by means of the processing algorithm. As long as the presence of the user is detected, this step S22 is repeatedly carried out. As soon as the control unit 36 determines that the user has left the area in front of the device 10, the preset tilt angle assigned to the home position is defined as new tilt angle to be adjusted in program step S24 and thereafter, in step S26, transmitted as adjustment angle to the subprogram for adjusting the tilt angle. After the home position tilt angle has been adjusted in step S26, the program is terminated in step S28.

In an advantageous development, the sequence is automatically repeatedly executed after termination in step S28 and is again started in step S10.

FIG. 8 shows a flow chart of a subprogram for adjusting a determined adjustment angle. The sequence is started in step S50. Thereafter, in step S52, the currently adjusted actual tilt angle α is determined. For this, for example, a last-adjusted tilt angle α stored in a memory unit of the control unit 36 is read out. Subsequently, it is checked in step S54 whether the adjusted actual tilt angle α corresponds to the adjustment angle. If this is the case, the sequence is subsequently terminated in step S56. Otherwise, in step S58, the angle difference between the actual tilt angle α and the adjustment angle is calculated by means of the control unit 36. In step S60, the control unit 36 then determines the sign of the angle difference.

If the angle difference has a positive sign, the sequence proceeds from step S60 to step S62. In step S62, the drive unit 34 is driven for changing the tilt of the display unit 12 such that the display unit 12 tilts upward in the first direction of rotation in the direction of the arrow P5 shown in FIG. 3. By means of the position sensor 88 described in FIG. 5, it is determined when the calculated angle difference has been reached. After the control unit 36 has determined that the display unit 12 has been tilted by the determined angle difference, the new tilt angle α is stored as new actual tilt angle α in the memory unit of the control unit 36 and, subsequently, the sequence is terminated in step S56.

If, however, it has been determined in step S60 that the sign of the angle difference is negative, the drive unit 34 is driven such that the display unit is tilted downward in the second direction of rotation opposite to the direction of the arrow P5 shown in FIGS. 3 and 4. Tilting of the display unit about the axis of rotation 40 takes place in the same manner as described in connection with step S62.

Likewise, the actual tilt angle α is stored in the memory unit of the control unit 36 as new actual tilt angle α before the sequence is terminated in step S56.

In the described embodiments, the face of the user is detected as body feature of the user. In other embodiments, however, also other body features such as the shoulder, the upper edge of the head, the hairline, and/or the eyes may be detected and their position in the image may be determined.

The entire disclosure of European Patent Application No. 11 186 147.2, filed Oct. 21, 2011, is expressly incorporated by reference herein.

What is claimed is:

1. A device (10) for handling banknotes, comprising:
a display unit (12) which is tiltable about an axis of rotation (40),
a drive unit (34) for changing the tilt angle (α) of the display unit (12) about the axis of rotation (40),
a camera (38) for capturing an image of an area in front of the device (10) opposite to the display unit (12), the camera (38) generating image data corresponding to the image,
a control unit (36) for processing the image data, the control unit (36) detecting a body feature of a user in front of the device (10) by means of a processing algorithm and determining the position of the detected body feature in the image,
wherein:
based on the determined position of the detected body feature, the control unit (36) determines a tilt angle (α), and
the control unit (36) drives the drive unit (34) such that it adjusts the determined tilt angle (α).

2. The device according to claim 1, wherein the device (10) comprises at least one operating element (28) by means of which a tilt angle different from the determined tilt angle (α) can be adjusted by the user.

3. The device according to claim 2, wherein the operating element (28) comprises a first push button for driving the display unit (12) about the axis of rotation (40) in a first direction of rotation and a second push button for driving the display unit (12) about the axis of rotation (40) in a second direction of rotation opposite to the first direction of rotation.

4. The device according to claim 1 wherein the display unit (12) has a rectangular display surface (14), the display surface (14) having a first side with a first side length and a second side with a second side length, wherein the first side and the second side enclosing a right angle.

5. The device according to claim 4, wherein when the device (10) is in the operating position, the first side is oriented horizontally.

6. The device according to claim 4, wherein along the second side of the display surface (14) and/or along a third side of the display surface (14) opposite to the second side, a plurality of push buttons (18) for selecting control information displayed via the user interface are arranged.

7. The device according to claim 1 wherein when the device (10) is in the operating position, the axis of rotation (40) is oriented horizontally.

8. The device according to claim 1 wherein a home position tilt angle is stored in a preset manner in the control unit (36), the control unit (36) driving the drive unit (34) such that it adjusts the home position tilt angle whenever a transaction initiated by the user is terminated or when the control unit (36) does not detect any user in the image captured by the camera (38).

9. The device according to claim 1 wherein the display unit (12) comprises a touch screen.
